(19) United States
(12) Patent Application Publication
(10) Pub. No.: US 2012/0184297 A1
(43) Pub. Date: Jul. 19, 2012

(54) WIRELESS LOCATION MEASUREMENT METHOD

(76) Inventors: Kanghee Kim, Daejeon (KR); Geon Min Yeo, Daejeon (KR); Jae Kyun Kwon, Daegu (KR); Kyungsu Yun, Daegu (KR); Kang-II Ahn, Daegu (KR)

(21) Appl. No.: 13/498,774

(22) PCT Filed: Sep. 29, 2010
(86) PCT No.: PCT/KR10/06636

§ 371 Date: Mar. 28, 2012

(30) Foreign Application Priority Data
Sep. 29, 2009 (KR) 10-2009-0092406
Sep. 13, 2010 (KR) 10-2010-0089625

(51) Int. Cl. H04W 24/00

(52) U.S. Cl. 455/456.1

(57) ABSTRACT

A method for a receiving node to find a distance from a transmitting node and measure a location includes: measuring a delay tab by receiving a location measurement signal from the transmitting node, temporarily determining a distance between the receiving node and the transmitting node by using the delay tab to compare it with a reference distance, selecting one of a distance estimation method using propagation delay and a distance estimation method using delay spread, and estimating a final distance.

### BACKGROUND OF THE INVENTION

(a) Field of the Invention

The present invention relates to a wireless location measurement method.

(b) Description of the Related Art

Wireless location measurement acquires information on position, speed, or features of things through wireless communication, and it can increase the accuracy of location measurement by using the global positioning system (GPS) scheme or a hybrid method combined with the GPS method. However, the GPS scheme has great accuracy but it may fail to receive GPS signals that are not in the line of sight (LOS) area of the satellite, particularly, at indoor spaces. When the signals are retransmitted terrestrially, a signal interference problem, a near-far problem, and a synchronization problem may occur. Further, a node with an installed GPS receiver can only receive the signals. To solve the restriction of the GPS method, various wireless location measurement methods have been researched.

The wireless location measurement methods include the angle of arrival (AOA) method, the received signal strength indicator (RSSI) method, the time of arrival (TOA) method, the time difference of arrival (TDOA) method, and the delay spread of arrival (DSOA) method. From among them, the TOA method and the TDOA method use propagation delay, and the DSOA method uses delay spread to be used for estimating the distance. However, regarding the TOA method and the TDOA method, when transmitting/receiving nodes are distant, the strength of the received signal is reduced and channel fading is added such that it is difficult to estimate an accurate distance. Regarding the DSOA method, the receiving node with little spreading and limited resolution may have difficulty in estimating an accurate distance when transmitting/receiving nodes are near. Therefore, the TOA method and the TDOA method have high accuracy of location measurement when the transmitting/receiving nodes are near, and the DSOA method has high accuracy of location measurement when the transmitting/receiving nodes are distant. Accordingly, when one location measurement method is used, the accuracy of location measurement is variable depending on the distance.

### SUMMARY OF THE INVENTION

The present invention has been made in an effort to provide a wireless location measurement method for improving the accuracy of location measurement.

An exemplary embodiment of the present invention provides a method for a receiving node to find a distance between the receiving node and a transmitting node and measuring a location of one of the receiving node and the transmitting node, including: receiving a location measurement signal from the transmitting node; measuring a delay tab based on the location measurement signal; temporarily determining the distance between the receiving node and the transmitting node by using the delay tab; comparing the temporary distance and a reference distance; selecting one of a distance estimation method using propagation delay and a distance estimation method using delay spread according to the comparison result; and estimating a final distance between the receiving node and the transmitting node through the selected estimation method.

The temporarily determining includes temporarily determining the distance by using one of the time of arrival method, the time difference of arrival method, and the delay spread of arrival method.

The selecting includes selecting the distance estimation method using propagation delay when the temporarily determined distance is less than the reference distance, and selecting the distance estimation method using the delay spread when the temporarily determined distance is greater than the reference distance.

The estimating of a final distance includes estimating the final distance by using the delay tab.

The method further includes determining a location of one of the receiving node and the transmitting node by using the final distance.

The determining of a location includes determining the location by using a triangulation based method.

Another embodiment of the present invention provides a method for finding a distance between a receiving node and a transmitting node with reference to the receiving node and measuring a location of one of the receiving node and the transmitting node, including: receiving a location measurement signal from the transmitting node; measuring a delay tab based on the location measurement signal; estimating a plurality of distances between the receiving node and the transmitting node by using the delay tab; and estimating a final distance between the receiving node and the transmitting node based on a distribution of the plurality of distances.

The plurality of distances include at least one distance estimated by using propagation delay and at least one distance estimated by using delay spread.

The estimated distance using the propagation delay includes an estimated distance estimated by using a delay time of a predetermined tab from among the delay tab.

The estimating of a final distance includes estimating an average of the plurality of distances as the final distance.

The average indicates a weighted average in consideration of the weight values set to the plurality of distances.

The estimating of a final distance includes estimating the final distance based on a difference among the plurality of distances.

The estimating of a final distance includes: comparing a maximum distance difference among the plurality of distances and a first reference value; estimating the final distance by using the plurality of distances when the maximum distance difference is less than the first reference value; and excluding the transmitting node from the location measurement when a location of the receiving node is measured and the maximum distance difference is greater than the first reference value.

The estimating of a final distance includes: comparing a maximum distance difference among the plurality of distances and a first reference value; estimating the final distance by using the plurality of distances when the maximum distance difference is less than the first reference value; determining whether a plurality of distances with the distance difference that is less than a second reference value from among the plurality of distances exist when the maximum distance difference is greater than the first reference value; when the plurality of distances exist, estimating the final distance by using the plurality of distances; and excluding the transmitting node from the location measurement when the location of the receiving node is measured and the plurality of distances do not exist.

According to an embodiment of the present invention, accuracy of location measurement can be increased irrespective of the distance between the transmitting/receiving nodes.

### BRIEF DESCRIPTION OF THE DRAWINGS

FIG. 1 shows a wireless location measurement method according to an exemplary embodiment of the present invention.

FIG. 2 shows a delay tab according to an exemplary embodiment of the present invention.

FIG. 3 shows a flowchart of a wireless location measurement method according to an exemplary embodiment of the present invention.

FIG. 4 to FIG. 7 show flowcharts and a drawing of a wireless location measurement method according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A wireless location measurement method according to exemplary embodiments of the present invention will now be described with reference to the drawings.

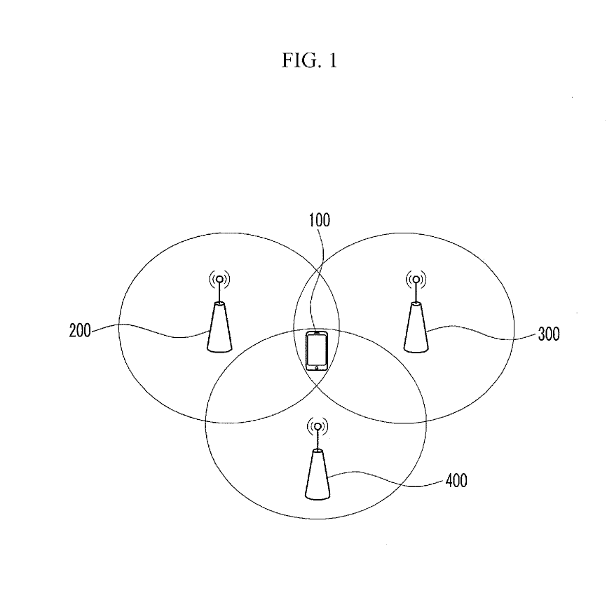

FIG. 1 shows a wireless location measurement method according to an exemplary embodiment of the present invention.

Referring to FIG. 1, a position of a location measurement target node 100 is determined by using distances between the location measurement target node 100 and a plurality of reference nodes. When a plurality of circles each having a reference node (200-400) as centers and having distances between the reference nodes (200-400) and the location measurement target node 100 as a radius are illustrated, the location where the plurality of circles are overlapped can be determined as the location of the location measurement target node 100. The location at which the circles are overlapped can be found by using an algorithm such as the least squares method based on triangulation when the distances between the location measurement target node 100 and the respective reference nodes (200-400) are known. In this instance, the distances between the location measurement target node 100 and the respective reference nodes (200-400) can be found through uplink location measurement or downlink location measurement. In the uplink location measurement, the location measurement target node 100 is a transmitting node for transmitting a location measurement signal and the reference nodes (200-400) are receiving nodes for receiving the location measurement signal, and in the downlink location measurement, the reference nodes (200-400) are transmitting nodes for transmitting the location measurement signal and the location measurement target node 100 is a receiving node for receiving the location measurement signal. In the following embodiments of the present invention, the downlink location measurement in which the location measurement target node 100 is a receiving node will be generally described, and the uplink location measurement is also applicable. A method for finding a distance between a location measurement target node 100 and reference nodes (200-400) will now be described.

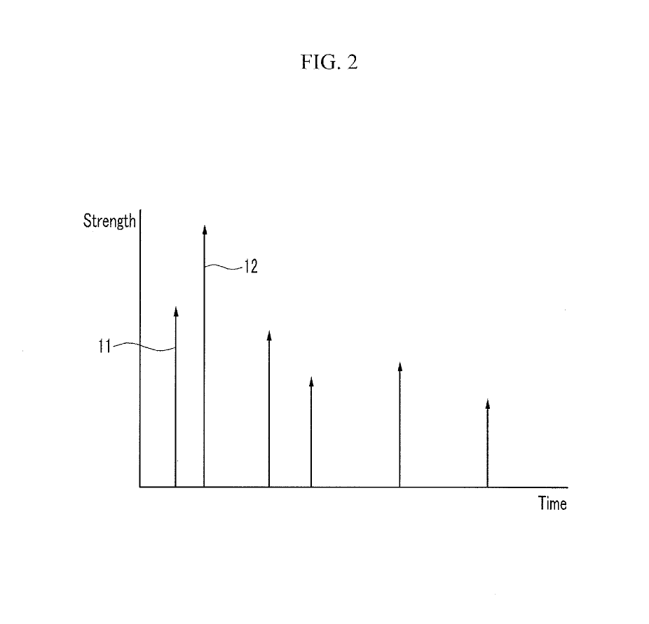

FIG. 2 shows a delay tab according to an exemplary embodiment of the present invention.

Referring to FIG. 2, the location measurement target node (100 of FIG. 1) receives a location measurement signal to find a delay tab of a radio wave. The horizontal axis of the delay tab represents the time of arrival of the radio wave indicating a delay time of the radio wave, and the vertical axis indicates signal strength. The location measurement target node 100 can know delay times of delay tabs including a first delay tab 11 and a maximum delay tab 12 with the maximum signal strength through the delay tab distribution, and can find a delay spread value for indicating a delay spread degree. The delay time or delay spread value acquired through the delay tab is proportional to the distance, and the distance between the transmitting/receiving nodes can be estimated by using the same.

Distance estimation using a delay time uses the propagation delay characteristic, and it can be found through the time of arrival (TOA) method or time difference of arrival (TDOA) method. In this instance, the accuracy of location measurement can be different according to the delay tab estimating the distance with reference to the time of arrival of a certain tab from among the tabs. If the signal strength of first delay tab from the reference node (e.g., 200 of FIG. 1) is the greatest, it corresponds to the case in which the location measurement target node 100 and the corresponding reference node 200 are located on the line of sight, so the distance is estimated by using the time of arrival of the first delay tab. However, the size of the first delay tab 11 can be like a distribution of the delay tab that is not the maximum because of reflection or diffraction of the radio wave as shown in FIG. 2. In this case, what is important is to select which delay tab so as to estimate the distance between the location measurement target node 100 that is not on the line of sight and the reference node 200. In this instance, the distance can be estimated by using a delay time of the first delay tab 11, a delay time of the maximum delay tab 12 having the maximum signal strength, or a delay time of the tab that has reached the earliest from among the delay tabs that are beyond a threshold value. Also, the distance can be estimated by using a statistical calculation method, such as an average of the delay times.

Distance estimation using delay spread can be found by the delay spread of arrival (DSOA) method. A delay spread value is found by the difference between the minimum delay time and the maximum delay time or the difference between the minimum delay time and the maximum delay time from among the delay tabs that are greater than the threshold value. In addition, the delay spread value can be found by a statistical calculation method, for example, by applying the root mean square (RMS) of the delay times of the respective delay tabs or the standard deviation of the delay times of the respective delay tabs.

The distance can be found by using a propagation delay of the delay tab or delay spread information, but since the respective methods have different accuracies according to the distances, the accuracy of location measurement can be reduced when one method is used to estimate the distance. Therefore, a method for estimating the distance by selectively using propagation delay or delay spread depending on the distance and a location measurement method for reducing an error by combining the same will now be described.

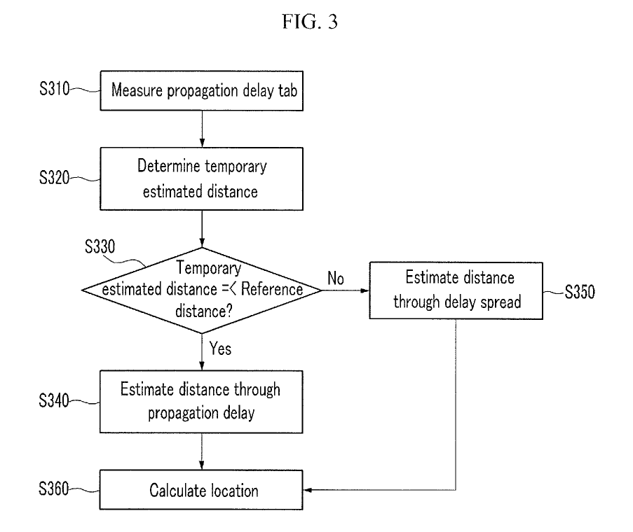

FIG. 3 shows a flowchart of a wireless location measurement method according to an exemplary embodiment of the present invention.

Referring to FIG. 3, in the case of downlink location measurement, the location measurement target node (100 of FIG. 1) receives a location measurement signal from a reference node (e.g., 200 of FIG. 1) to measure the delay tab (S310).

The location measurement target node 100 estimates the distance by using the delay tab, and determines the estimated distance to be a temporary estimated distance (S320). The temporary estimated distance is used as information for selecting the estimation method using propagation delay and the estimation method using delay spread. The temporary estimated distance can be determined by various methods using the delay tab, and the various methods include the TOA, TDOA, and DSOA methods.

The location measurement target node 100 compares the temporary estimated distance and the reference distance (S330). The reference distance can be determined in consideration of the error that occurs depending on the distance when the estimation method using propagation delay and the estimation method using delay spread are used.

When the temporary estimated distance and the reference distance are compared to find that the temporary estimated distance is less than the reference distance, the location measurement target node 100 estimates the final distance according to the estimation method using propagation delay (S340). When the temporary estimated distance is greater than the reference distance, the location measurement target node 100 estimates the final distance by using the estimation method using delay spread (S350). The location measurement target node 100 can use the delay tab when estimating the final distance by using propagation delay or delay spread. Particularly, when the propagation delay is used, the final distance can be estimated by using the TOA or TDOA method, and when the delay spread is used, the same can be estimated by using the DSOA method.

Since a plurality of reference nodes and distance information are needed so as to determine the location, the location measurement target node 100 calculates the location of the location measurement target node 100 based on various methods such as the triangulation method by estimating the distance with other reference nodes (300 and 400 of FIG. 1) (S360).

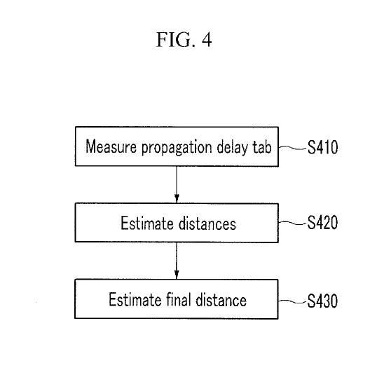

FIG. 4 to FIG. 7 show flowcharts and a drawing of a wireless location measurement method according to another exemplary embodiment of the present invention.

Referring to FIG. 4, the location measurement target node (100 of FIG. 1) receives a location measurement signal from a reference node (e.g., 200 of FIG. 1) to measure the delay tab (S410).

The location measurement target node 100 estimates a plurality of distances by using the delay tab (S420). The respective estimated distances can be found by using one of the estimation method using propagation delay and the estimation method using delay spread and using different information, respectively. For example, the plurality of estimated distances include a distance estimated with a delay time of the first delay tab, a distance estimated with a delay time of the delay tab indicating the maximum signal strength, and a distance estimated by using a delay spread value.

The location measurement target node 100 estimates the final distance in consideration of a distribution of the estimated distances (S430). The final distance can be determined by using a statistical calculation method, for example, the weighted average that considers the average of the estimated distances or weight values of the respective distances. In this instance, when the difference among a plurality of estimated distances is large, the correction using the statistical calculation method will also increase the error, and so a method for reducing the error will now be described.

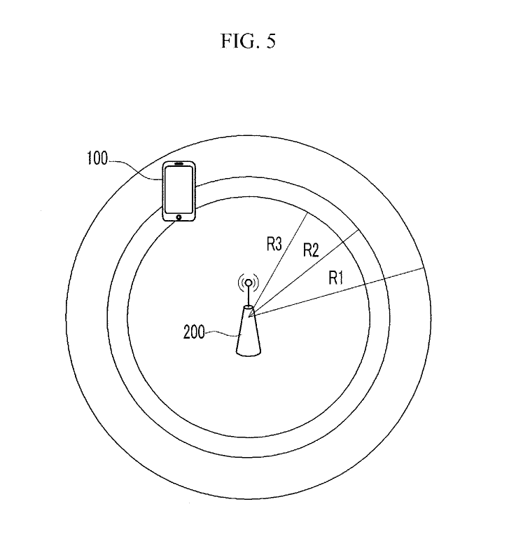

Referring to FIG. 5, a plurality of estimated distances, for example, three estimated distances (R1-R3), between the location measurement target node (100 of FIG. 1) and the reference node (e.g., 200 of FIG. 1) are found by using the delay tab. When the final distance between the location measurement target node 100 and the reference node 200 is determined, the distance differences among a plurality of estimated distances are considered. When a plurality of estimated distances (R1-R3) are similarly distributed, the accuracy of location measurement can be increased by estimating the distance by using the estimated distances (R1-R3), and when the differences among the estimated distances (R1-R3) are large, the accuracy thereof can be reduced when the estimated distance (R1-R3) are used.

The location measurement target node 100 estimates the final distance by considering the plurality of estimated distances (R1-R3) when the maximum distance difference between the estimated distances (R1-R3) is less than the reference value. However, when the maximum distance difference is greater than the reference value, the reference node 200 can be excluded from location measurement since the error among the estimated distances (R1-R3) is large. In addition, when the maximum distance difference is greater than the reference value, the estimated distances R2 and R3 showing similar distributions from among the plurality of estimated distances (R1-R3) can be used to find the final distance. Determination on the similar distribution can be performed by setting a second reference value differing from the above-noted reference value, and when the distance between the estimated distances R2 and R3 is less than the second reference value, the corresponding estimated distances R2 and R3 can be determined to be an estimated distance showing a similar distribution.

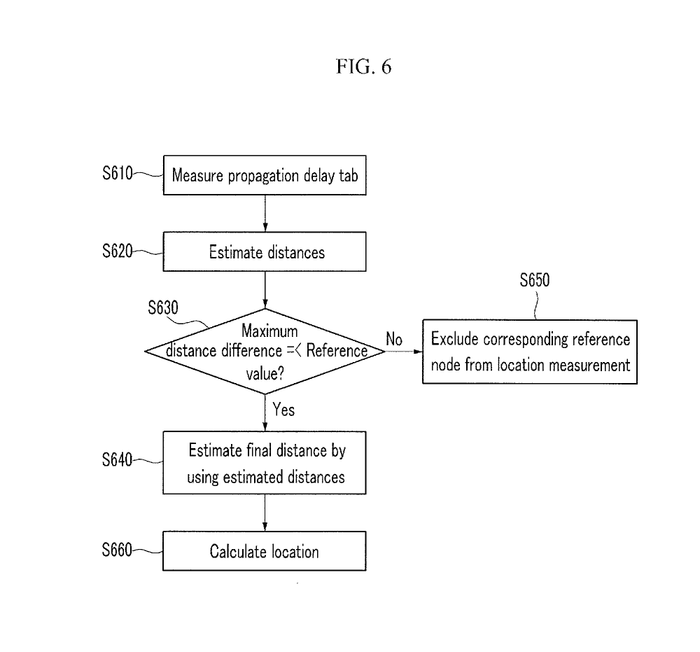

Referring to FIG. 6, the location measurement target node (100 of FIG. 1) receives a location measurement signal from the reference node (e.g., 200 of FIG. 1) to measure the delay tab (S610).

The location measurement target node 100 estimates a plurality of distances (e.g., R1-R3 of FIG. 5) by using the delay tab (S620). The respective estimated distances can be found by using one of the estimation method using propagation delay and the estimation method using delay spread.

The location measurement target node 100 compares the maximum distance difference among a plurality of estimated distances (R1-R3) and the reference value (S630).

The location measurement target node 100 estimates the final distance by using a plurality of estimated distances (R1-R3) when the maximum distance difference is less than the reference value (S640). The final distance can be found by a statistical calculation method using a plurality of estimated distances (R1-R3), for example, an average of a plurality of estimated distances or a weighted average of the respective distances to which a weight value is applied.

The location measurement target node 100 excludes the reference node 200 from location measurement when the maximum distance difference is greater than the reference value (S650) because location measurement may have an error when the reference node with the maximum distance difference that is greater than the reference value is used for location measurement.

In this way, the distance with other reference nodes (300 and 400 of FIG. 1) is estimated to calculate the location of the location measurement target node (S660). Here, when the reference node 200 is unconditionally excluded from location measurement when the maximum distance difference is greater than the reference value, the number of reference nodes required for location measurement may not be acquired. In this case, it is possible to select the estimated distances that have similar distributions from a plurality of estimated distances (R1-R3) and use them for location measurement instead of excluding the reference node 200 having the maximum distance difference among a plurality of estimated distances (R1-R3) greater than the reference value.

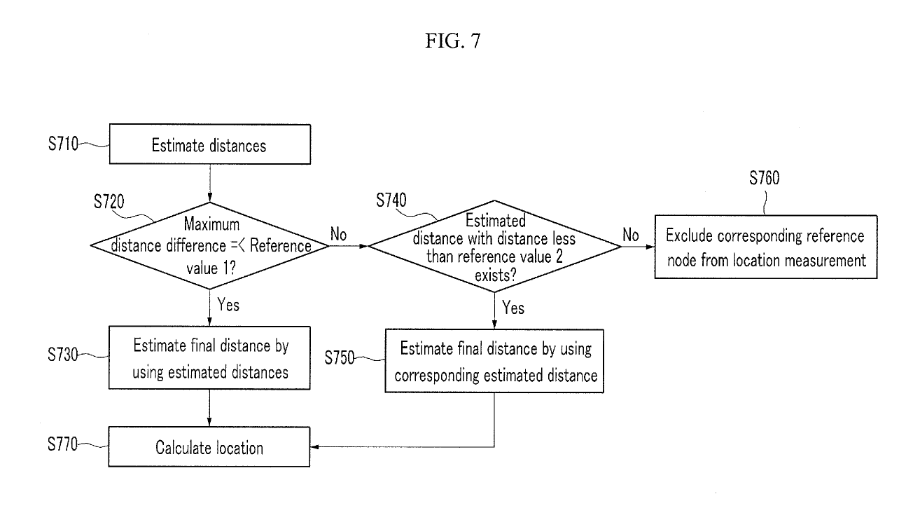

Referring to FIG. 7, in the method for estimating the final distance in consideration of the distribution of a plurality of estimated distances, the location measurement target node (100 of FIG. 1) finds a plurality of estimated distances (e.g., R1-R3 of FIG. 5) between the location measurement target node 100 and the reference node (e.g., 200 of FIG. 1) (S710), and compares the maximum distance difference of a plurality of estimated distances (R1-R3) and the reference value (S720).

The location measurement target node 100 estimates the final distance by using a plurality of estimated distances (R1-R3) when the maximum distance difference is less than the reference value (S730).

When the maximum distance difference is greater than the reference value, the location measurement target node 100 sets a second reference value different from the reference value compared to the maximum distance difference, and determines whether a plurality of estimated distances that are less than the second reference value exist (S740).

When the plurality of estimated distances that are less than the second reference value exist, the location measurement target node 100 estimates the final distance by using the corresponding estimated distance (S750).

If not, the location measurement target node 100 excludes the reference node 200 from location measurement (S760).

In this way, the distances with a plurality of reference nodes (300 and 400 of FIG. 1) are estimated to calculate the location of the location measurement target node 100 (S770).

Two reference values for comparing the difference between a plurality of distances are set in FIG. 7, and it is also possible to increase the number of reference values in consideration of the number of the estimated distances and compare the distance difference and the reference value.

The downlink location measurement for the location measurement target node 100 to receive the location measurement signal and calculate the distance with the reference nodes (200-400) has been described, and the uplink location measurement is also applicable. The method for the location measurement target node 100 to measure the delay tab and find the distance has been described, and the location measurement target node 100 can collect information for location measurement from the reference nodes (200-400) and transmit the same to another device, for example, a location measurement server (not shown) or the reference nodes (200-400) to calculate the location of the location measurement target node 100 instead of calculating the location of the location measurement target node 100.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a receiving node to find a distance between the receiving node and a transmitting node and measuring a location of one of the receiving node and the transmitting node, comprising:
receiving a location measurement signal from the transmitting node;
measuring a delay tab based on the location measurement signal;
temporarily determining the distance between the receiving node and the transmitting node by using the delay tab;
comparing the temporary distance and a reference distance;
selecting one of a distance estimation method using propagation delay and a distance estimation method using delay spread according to the comparison result; and
estimating a final distance between the receiving node and the transmitting node through the selected estimation method.

2. The method of claim 1, wherein
the temporarily determining includes
temporarily determining the distance by using one of the time of arrival method, the time difference of arrival method, and the delay spread of arrival method.

3. The method of claim 1, wherein
the selecting includes:
selecting the distance estimation method using propagation delay when the temporarily determined distance is less than the reference distance; and
selecting the distance estimation method using the delay spread when the temporarily determined distance is greater than the reference distance.

4. The method of claim 1, wherein
the estimating of a final distance includes
estimating the final distance by using the delay tab.

5. The method of claim 1, further including
determining a location of one of the receiving node and the transmitting node by using the final distance.

6. The method of claim 5, wherein
the determining of a location includes determining the location by using a triangulation based method.

7. A method for finding a distance between a receiving node and a transmitting node with reference to the receiving node and measuring a location of one of the receiving node and the transmitting node, comprising:
receiving a location measurement signal from the transmitting node;
measuring a delay tab based on the location measurement signal;
estimating a plurality of distances between the receiving node and the transmitting node by using the delay tab; and
estimating a final distance between the receiving node and the transmitting node based on a distribution of the plurality of distances.

8. The method of claim 7, wherein
the plurality of distances include
at least one distance estimated by using propagation delay and at least one distance estimated by using delay spread.

9. The method of claim 8, wherein
the estimated distance using the propagation delay includes
an estimated distance estimated by using a delay time of a predetermined tab from among the delay tabs.

10. The method of claim 7, wherein
the estimating of a final distance includes
estimating an average of the plurality of distances as the final distance.

11. The method of claim 10, wherein
the average indicates a weighted average in consideration of the weight values set to the plurality of distances.

12. The method of claim 7, wherein
the estimating of a final distance includes
estimating the final distance based on a difference among the plurality of distances.

13. The method of claim 12, wherein
the estimating of a final distance includes:
comparing a maximum distance difference among the plurality of distances and a first reference value;
estimating the final distance by using the plurality of distances when the maximum distance difference is less than the first reference value; and
excluding the transmitting node from the location measurement when a location of the receiving node is measured and the maximum distance difference is greater than the first reference value.

14. The method of claim 12, wherein
the estimating of a final distance includes:
comparing a maximum distance difference among the plurality of distances and a first reference value;
estimating the final distance by using the plurality of distances when the maximum distance difference is less than the first reference value;
determining whether a plurality of distances with the distance difference that is less than a second reference value from among the plurality of distances exist when the maximum distance difference is greater than the first reference value;
when the plurality of distances exist, estimating the final distance by using the plurality of distances; and
excluding the transmitting node from the location measurement when the location of the receiving node is measured and the plurality of distances do not exist.
